(19) United States
(12) Patent Application Publication
(10) Pub. No.: US 2014/0019383 A1
(43) Pub. Date: Jan. 16, 2014

(54) Means by which to examine and clarify responsibilities between counter parties in a fiduciary relationship

(71) Applicant: Dennis F. Mahoney, West Chester, PA (US)

(72) Inventor: Dennis F. Mahoney, West Chester, PA (US)

(21) Appl. No.: 13/986,689

(22) Filed: May 25, 2013

Related U.S. Application Data
(63) Continuation-in-part of application No. 13/507,647, filed on Jul. 16, 2012, now Pat. No. 8,452,685.

(51) Int. Cl. G06Q 40/06

(52) U.S. Cl. CPC G06Q 40/06
USPC 705/36 R

(57) ABSTRACT

A process by which to examine and clarify responsibilities between counter-parties in a fiduciary, contractual or other relationship which entails legal responsibilities, obligations and potential liabilities by determining knowledge of and competency regarding the nature of the relationship using performance scores from a psychometric testing instrument to determine whether individuals or groups understand said relationship.

### CROSS-REFERENCE TO RELATED APPLICATIONS

This application is a continuation-in-part of application Ser. No. 13/507,647, filed Jul. 16, 2012, now U.S. Pat. No. 8,452,685 granted May, 28, 2013 which was a continuation of application Ser. No. 12/079,119, filed Mar. 25, 2008, now U.S. Pat. No. 8,224,732 granted Jul. 17, 2012. The patent applications identified above are incorporated here by reference in their entirety to provide continuity of disclosure.

### BACKGROUND OF THE INVENTION

1. Field of the Invention

This invention relates to the field of compensation and employee benefits and, in particular, to methods for reducing fiduciary liability for employers and plan sponsors when permitting plan participants to choose benefit options or self-direct plan investments.

2. Background of the Invention

Increasingly compensation and employee benefit plans have permitted employees to make choices and selections as to the form that their compensation and employee benefit coverage takes. This is true of health and welfare plans where such programs as flexible benefit plans under Section 125 of the Internal Revenue Code are permitted, and in the retirement planning area where employees select their own investments under self-directed defined contribution plans. In the retirement savings area, many employers have moved away from defined benefit plans to defined contribution plans. Within these defined contribution plans, many of which involve Section 401(k), Section 403(b) or Section 457(b) arrangements, employers permit employees to select their own plan investments. At the same time, the Employee Retirement Income Security Act (ERISA) of 1974 imposes fiduciary responsibilities on the employer sponsoring the plan to assure the suitability of the various investment options at inception and to continue to monitor these investment options for their suitability on an ongoing basis. (For plans not specifically subject to ERISA-imposed fiduciary liability, many of these plans will follow the precepts and legal principles established by ERISA plans as models of “best practices.” This would be true of governmental plans and church plans that are exempt from ERISA-imposed fiduciary requirements. Accordingly, the invention described in this patent application would also have relevance to these non-ERISA plans as a “best practice” or under general trust law for assuring the best interests of plan participants even if a plan is not subject to ERISA under the law.)

In recent years, the extent to which an employer must exercise “due diligence” with monitoring investment suitability has been a subject of judicial review. Fiduciaries are required to act prudently in selecting and monitoring plan investments. With the transformation of the private pension system to one where employees make decisions regarding their own plan investments, other issues such as what an employer can do to facilitate investment education and who is able to provide investment advice have been undergoing major change.

The extent to which a plan sponsor must exercise “due diligence” regarding participant—directed plan investments was clarified in litigation tied to the massive bankruptcy of the Enron Corporation. The legal citation for this case is: Enron Corporation Securities, Derivative and ERISA Litigation, 284 F. Supp. 2d 511 (S. D. Tex. 2003). The decision by Judge Harmon, the presiding judge in the case, along with the “friend of the court” brief filed by the Department of Labor (DOL) clarified the fiduciary responsibilities of plan sponsors for participant-directed investments in an ERISA plan.

As statutorily determined under ERISA, the trustee or named fiduciaries of a plan are responsible for the investment of plan assets. [See ERISA ss405(c)] The trustee or named fiduciaries may appoint an investment manager (as defined in ERISA Section 3(38)), which will relieve the fiduciaries of responsibility for managing the investments, [see ERISA ss4 05(d)] but they must prudently select and monitor the manager. Section 404(c) of ERISA provides a procedure under which fiduciaries may be relieved of liability for losses resulting from a participant's exercise of control over his or her own account. To obtain 404(c) relief, the plan must comply with roughly 20 requirements found in the DOL regulation.

In her decision, Judge Harmon stated: “If a plan does not qualify as a 404(c) [plan], the fiduciaries retain liability for all investment decisions made, including decisions by the Plan participants.” [emphasis added] This decision by Judge Harmon was aligned with the “friend of the court” brief filed by the DOL in the Enron case which stated:
The only circumstance in which ERISA relieves the fiduciary of responsibility for a participant-directed investment is when the plan qualifies as a 404(c) plan under ERISA ss404(c) . . . a fiduciary is not liable for losses to the plan resulting from the participant's selection of investments in his own account, provided that the participant exercised control over the investment and the plan met the detailed requirements of a Department of Labor regulation.

Below is cited commentary by an expert on fiduciary liability explaining the implications of this landmark judicial decision on fiduciary liability issues for employee benefit plan sponsors:
What the Enron decision emphasizes is these responsibilities apply even to investment decisions made by the participants with respect to their own accounts—unless the plan complies with the requirements of ERISA Section 404(c). This is a powerful statement, because, for participant-directed plans, it places the responsibility for the prudence of participant investment decisions on the fiduciaries. Why? Because, in our experience, few plans actually comply with the requirements for 404(c) protection. It is commonly understood that fiduciaries remain responsible for selecting the investment options in participant-directed plans. Many fiduciaries, and most advisors, also know that fiduciaries can only be relieved of responsibility for the investment of participant accounts if the participants actually exercise investment control. What has not been commonly understood is that the fiduciaries can only be relieved of liability for participant investment decisions if the plan meets the detailed requirements of the DOL's 404(c) regulations. [DOL Reg.ss2550 404(c)-1; . . . ]
Put another way, the fiduciaries remain responsible for the prudence of the participant investment decisions even though the participants make the decisions. Merely allowing participants to decide how to invest their own accounts is not enough; the fiduciaries must take steps to ensure that the plan provides a broad range of investment options, provides the participants with the opportunity to exercise control over their accounts, and provides the participants with information sufficient to enable them to make informed investment decisions. And that must be done in a way that satisfies the 20 or so specific requirements in the regulation. If these requirements are not met, the fiduciaries are charged with the responsibility for the participants' decisions. Needless to say, this strongly reinforces the importance of complying with the 404(c) requirements—and the need to provide an investment structure that supports well-invested participant accounts (such as age-based life cycle or risk-based life style funds, managed accounts, or asset allocation models). (Reish, pp. 3-4, Lessons from the Enron Litigation)

Until the legal clarifications were made in the previously stated court case, the extent to which a plan sponsor or fiduciary possesses fiduciary liability for participant-directed plan choices was not fully understood and appreciated by most plan sponsors. Now as plan sponsors become aware of their potential liability exposure in these areas, they will look to find business methods that decrease or avoid such liability. As recommended by the expert (Reish) on fiduciary liability, several approaches are available to support the goal of an investment structure that supports well-invested participant accounts. One such approach suggested above is using an asset allocation model. Here an individual would determine an asset allocation approach that incurs the amount of risk he or she is willing to accept consistent with the risks and returns that various asset classes have exhibited historically.

Another approach would entail use of a risk-based life style fund. A risk based life style fund is a single fund or fund of funds whose asset allocation weightings are determined by how much risk an individual seeks to incur. One might select from a “conservative,” “moderate,” or “aggressive” allocation. Typically the “aggressive” allocation would have the largest weighting in equities. These funds free investors from having to rebalance their portfolios over time if they have selected a particular amount of risk they seek to incur. The portfolio manager would automatically rebalance the portfolio to preserve the asset allocation consistent with the risk preference initially selected.

Another approach suggested above is an age-based lifestyle fund. These types of funds are also called target date retirement funds. “Target date retirement funds are the most important 401(k) product development initiative to come along in the last ten years, and I give credit to Fidelity (Investments) for pioneering this concept with the introduction of the Freedom Funds targets in October of 1996 . . . Target date funds are no more than any other asset allocation or a life cycle fund with two rather uncomplicated twists: (a) the fund has wisely been ‘labeled’ to correspond with an anticipated year of retirement, and (b) rather than keeping the allocation static, the fund's equity exposure gradually slides down a ‘glide path’ over time.” (Malone, p. 1 Mar. 23, 2006)

Yet another approach would be to use a managed account. With a managed account, an investment manager would look to manage investments consistent with pre-determined risk levels that are made known to investors. Some investment professionals have actually suggested use of a questionnaire to determine risk preference and then manage multiple accounts that would tailor investments in those specific accounts to the identified risk preferences of investors. This approach would avoid participants directing their own investments and leave the investing responsibilities with the investment manager selected by the plan sponsor. (Chang, Simon, and Allen, 2005)

Although many of the aforementioned investment structures have significant advantages, they also have certain disadvantages. A primary and significant disadvantage common to all of the aforementioned investment structures is that they curtail the ability of the individual participant to select investments that he or she expects will provide the best investment return given his or her individual risk profile. For the knowledgeable investor, the ability to self-direct one's plan investments holds significant appeal. All of these other suggested investment structures serve to limit fiduciary liability exposure for the plan sponsor, but in doing so, restrict the freedom of the individual plan participant to customize his or her benefit plan.

Following the Enron decision, another court case was decided involving a plan sponsor that did not qualify for 404(c) protection. In this decision, (Jenkins v. Yager & Mid America Motorworks, Inc., No. 04-4258 7^{th} Circuit, Apr. 14, 2006), it was held that ERISA section 404(c) is only a safe harbor and the actions of the plan trustee, when delegating decision-making authority to plan participants, must be evaluated to see if they violate a trustee's fiduciary duty. In Jenkins v. Yager & Mid America Motorworks, Inc., the Court found that “Mr. Yager provided his employees with the necessary information to enable them to direct their investments in the 401(k) Plan, including by holding yearly meetings with a financial advisor to discuss investments in the 401(k) Plan.”(White & Case, p. 3) The significance of the Yager decision is that it allows plan sponsors to prove they did not violate a trustee's fiduciary duty if they take proactive steps that are beneficial to participant decision-making. The suggested invention provides a means for a plan sponsor or fiduciary to limit fiduciary liability exposure while preserving the ability of the individual participant to customize his or her benefit plan.

Following passage of the Pension Protection Act of 2006 (PPA), enacted into law in August of 2006, the Department of Labor (DOL) issued guidance concerning default investments in participant directed individual account plans. The following background and guidance was provided:
“With the enactment of the PPA, section 404(c) of ERISA was amended to provide relief afforded by section 404(c)(1) to fiduciaries that invest participant assets in certain types of default investment alternatives in the absence of participant investment direction. Specifically, section 624(a) of the PPA added a new section 404(c)(5) to ERISA. Section 404(c)(5)(A) of ERISA provides that, for purposes of section 404(c)(1) of ERISA, a participant in an individual account plan shall be treated as exercising control over the assets in the account with respect to the amount of contributions and earnings which, in the absence of an investment election by the participant, are invested by the plan in accordance with regulations prescribed by the Secretary of Labor. Section 624(a) of the Pension Protection Act directed that such regulations provide guidance on the appropriateness of designating default investments that include a mix of asset classes consistent with capital preservation or long-term capital appreciation, or a blend of both. In the Department's view, this statutory language provides the stated relief to fiduciaries of any participant directed individual account plan that complies with its terms and with those of the Department's regulation under section 404(c)(5) of ERISA. The relief afforded by section 404(c)(5), therefore, is not contingent on a plan being an ‘ERISA 404(c) plan’ or otherwise meeting the requirements of the Department's regulations at ss 2550.404c-1. The amendments made by section 624 of the Pension Protection Act apply to plan years beginning after Dec. 31, 2006.
On Sep. 27, 2006, the Department, exercising its authority under section 505 of ERISA and consistent with section 624 of the Pension Protection Act, published a notice of proposed rulemaking in the Federal Register (71 FR 56806) that, upon adoption, would implement the provisions of ERISA section 404(c)(5).”(Federal Register (29 CFR Part 2550, p. 60452)

The final rules were published in the Federal Register on Oct. 24, 2007 and these final rules had an effective date of Dec. 24, 2007. It is not entirely certain as to the effect of these relatively recently issued final rules on default investments on the implementation and use of the invention in this patent application. It is believed by the inventor that the use of this invention may be integrated within the enrollment and ongoing monitoring functions of a plan sponsor and be compatible with the rules of default investments.

The invention described in this patent application is particularly timely. On Feb. 20, 2008, the U.S. Supreme Court decided the case of LaRue v. DeWolff, Boberg& Associates, Inc., et al. This case clarified that individual participants in 401(k) and other retirement plans subject to ERISA have standing to sue plan fiduciaries to recover investment losses from their accounts. Previously when the Supreme Court decided the case of Massachusetts Mutual Life Insurance Co. v. Russell, it had held that individual participants could not bring an ERISA claim “to recover consequential damages,” but could only seek recovery by “the plan as an entity.” LaRue renders this prior holding irrelevant and permits a plan participant to pursue “damages” to the plan, even where measured solely by the injury to the plan participants' individual accounts (Thompson Hine, p. 1). This important case was reported in The New York Times, Wall Street Journal, and the Washington Post newspapers on Feb. 21, 2008. (New York Times, pp. 1-2, Wall Street Journal, p. D1, and Washington Post, p. A01). This precedent-setting case is likely to result in increased litigation against plan sponsors by plan participants. Accordingly, the invention described in this patent application may assist plan sponsors in avoiding such litigation.

Employees who have been defaulted into investment choices may be particularly at risk should a market downturn occur, particularly if they are not well-informed investors. If invention is used as part of the enrollment process, it may protect less well-informed investors from fleeing beneficial long-term default investments prematurely when market corrections occur.

Currently there are various administrative record-keeping systems for processing benefits transactions. The patent to El-Kadi and Derienzo (U.S. Pat. No. 6,014,642) relates to a system for processing investment information, participant data and financial transactions with respect to employee benefits programs. Similarly, there are systems that provide for tracking and accounting of plan choices. The patent to Gilbert and Gupta (U.S. Pat. No. 6,041,313) relates generally to the field of computer-based retirement plan tracking and accounting with specific application to a modified 401(k) retirement plan. There have also been patents disclosing inventions that serve to allow investors to screen investments for appropriateness and that allow investors to assess their personal financial risk tolerance. The invention in a patent of Maggioncalda, Jones, Sharpe, Fine, and Tauber (U.S. Pat. No. 5,918,217) allows a user to explore how changes in risk tolerance, savings level and retirement age affect the probability of achieving one's financial goal. The patent of Davey (U.S. Pat. No. 6,859,788) discloses a method and system for the automated assessment of personal financial risk tolerance. The patent of Rebane (U.S. Pat. No. 6,078,904) discloses a system for optimally allocating investment funds of an investor in a portfolio having a plurality of investments.

The field of psychometrics has produced various types of testing instruments to ascertain measures of knowledge, aptitudes and proficiency. The patent of Penno (U.S. Pat. No. 6,705,870) discloses one such example. Some of these methods involve computer-implemented methods such as the method disclosed in the patent of Calhoun, Peterson and Merzenich (U.S. Pat. No. 6,565,359) which relates to a computer-implemented method and apparatus for remote cognitive and/or perceptual testing. Some of these methods and apparatuses provide a means of training as well as testing. The patent of Breznitz (U.S. Pat. No. 6,632,174) discloses a method for testing and/or training cognitive ability. Some of these testing and training instruments involve a simulation or case study. The invention in a patent of Gray and Coons (U.S. Pat. No. 6,944,596) makes use of an education business simulation. Some testing and training approaches make use of a technique known as adaptive testing. The invention in a patent of Moore, Cleveland, Vulfs, Carter, Cahill, and Heinz (U.S. Pat. No. 6,925,601) uses an adaptive testing tool. Once any type of cognitive or psychological test is administered, there usually is a method to record and retain performance. The patent of Poreh (U.S. Pat. No. 6,629,846) discloses a method for recording performance in psychological tests.

Although various types of psychometric testing instruments exist, they have not been used in conjunction with compensation and benefit plan enrollment systems to determine whether plan participants possess sufficient knowledge or capability to make certain plan choices. In accordance with my invention, using a measure of performance on a psychometric testing instrument to determine an array of either recommended plan selections or allowable choices under a plan protects plan participants and their beneficiaries. My inventive business method also allows plan sponsors to limit fiduciary liability and proactively fulfill their fiduciary responsibilities.

Additional Description Relevant to Continuation-In-Part Application:

It is helpful to further explore details regarding fiduciary duties as prescribed by law:

### Nature of Fiduciary Duties

“A fiduciary duty is an obligation to act in the best interest of another party. For instance, a corporation's board member has a fiduciary duty to the shareholders, a trustee has a fiduciary duty to the trust's beneficiaries, and an attorney has a fiduciary duty to a client. A fiduciary obligation exists whenever the relationship with the client involves a special trust, confidence, and reliance on the fiduciary to exercise his discretion or expertise in acting for the client. The fiduciary must knowingly accept that trust and confidence to exercise his expertise and discretion to act on the client's behalf . . . The client is entitled to the best efforts of the fiduciary on his behalf and the fiduciary must exercise all of the skill, care and diligence at his disposal when acting on behalf of the client. A person acting in a fiduciary capacity is held to a high standard of honesty and full disclosure in regard to the client and must not obtain a personal benefit at the expense of the client.” (Breach of Fiduciary Law & Legal Definition 1)

The nature of fiduciary duty can be segmented further which has been pointed out by legal scholars who have explored the essence of fiduciary duty.

“Fiduciary duties fall into two broad categories: the duty of loyalty and the duty of care. These duties vary with different types of relationships between fiduciaries and their counter-parties ('entrustors'). Recently, courts have imposed fiduciary duties on union officers, physicians and clergymen . . .

Arrangements in which entrustors are precluded from controlling their fiduciaries in the performance of their services, categorized in law as ‘trust,’ vest far more power in the fiduciaries than arrangements, categorized in law as ‘agency,” in which entrustors control their fiduciaries in the performance of their services . . .

The sole purpose of entrustment is to enable fiduciaries to serve their entrustors. Entrustment enables fiduciaries to use entrusted power for other purposes for their own use or the use of third parties . . . ” (Frankel 127)

### Though Centuries Old, Fiduciary Duties Are Undergoing Unprecedented Change

First: In the Realm of Retirement Plans and Investment Management

In the context of retirement planning and investment management, increasing sophistication of product offerings and services along with specialization by service providers is leading to change.
“Fundamental fiduciary principles have survived intact for centuries, yet their interpretation has been dynamic. Given changes over the past few decades in global economic, capital management, and market structures, we appear to be at another inflection point in the understanding of fiduciary principles . . .
Fiduciary duty is grounded on a relatively stable set of legal principles that have survived for centuries. However, interpretation of fiduciary principles can be quite dynamic. We are again at an inflection point, where our understanding and appreciation of fiduciary duty is evolving rapidly. In response to recent changes in financial markets, economic changes, and changes in the asset management industry, fiduciaries are examining the continued appropriateness of norms and beliefs carried over from the twentieth century . . .
Increased market complexity has generated a longer and more conflicted chain of service providers that have growing influence over governing fiduciaries . . .
These developments present a compelling case for evaluation of how fiduciary principles and practices might be better aligned to promote sustainable pension (and other retirement investment) success. Such a process is likely to be an extended journey of discovery rather than a single event of enlightenment . . .
Expansion of Service Provider Influence: Innovation in the creation of financial instruments, products, and services has produced a far more complex investment marketplace. Nearly every aspect of investment management now requires specialized expertise. This has generated a vast new industry of service providers upon whom pension (or other retirement plan) trustees (and/or administrators) rely . . . ” (Hawley, Johnson, Waitzer 4-5)

Second: In Broader and More Diverse Realms

Not only are fiduciary relationships changing in the realms of retirement planning and investment management, but in many other areas of society as well. This can be seen with courts expanding the dimensions in which fiduciary duties are required. Experts in fiduciary law have noted this expansion.
“When does a person owe another a fiduciary duty? Unless their relationship is one of the classic relationships that impose fiduciary duties, such as the attorney/client, executor/heir, guardian/ward, agent/principal, trustee/beneficiary, or corporate officer/shareholder, the answer is often unclear. Courts in recent years have imposed a fiduciary duty on persons in numerous other types of relationships. Depending on the particular facts, lenders, clerics, and even wives have all been saddled with fiduciary duties. Commentators have attempted to isolate a defining principle that specifies the circumstances or relationships that warrant the imposition of fiduciary duties. None of their theories, however, fully captures the myriad applications of fiduciary duty, leading one commentator to refer to the fiduciary relationship as “one of the most elusive concepts in Anglo-American law,” another to describe it as “a concept in search of a principle,” and yet another to state that it may be more accurate to speak of relationships having a fiduciary component to them rather than to speak of fiduciary relationships as such . . .
At the heart of the courts' interpretations of the fiduciary relationship is a concern that persons who assume trustee-like positions with discretionary power over the interests of others might abuse their position . . .
No one principle fully captures all the circumstances in which a fiduciary duty is imposed because the concept of owing a fiduciary duty was not originally conceived as a strict legal rule. Instead, it is fundamentally a flexible equitable concept that arose to provide relief when no legal remedy was available. It is applied through analogy to circumstances in which fiduciary duties conventionally apply and is, therefore, necessarily situation-specific. Understanding its origin and historical development, described in a somewhat lengthy endnote, is important to understand its proper application. The language used by the courts to describe the fiduciary relationship reflects its historical origin in equity. For instance, in Doe v. Evans, 814 So. 2d 370, 374 (Fla. 2002), quoting Quinn v. Phipps, 113 So. 419, 421 (Fla. 1927), the Florida Supreme Court, using centuries old language, characterized the fiduciary relationship as follows:
The relation and duties need not be legal; they may be moral, social, domestic, or personal. If a relation of trust and confidence exists between the parties (that is to say, where confidence is reposed by one party and trust accepted by the other, or where confidence has been acquired and abused), that is sufficient as a predicate for relief.
The court in Doe v. Evans, 814 So. 2d 370, 374 (Fla. 2002) also stated that “ a fiduciary relation exists between two persons when one of them is under a duty to act for or to give advice for the benefit of another upon matters within the scope of that relation,” relying on Comment a to Section 874 of the Restatement (Second) of Torts. Comment a has been fairly criticized as being both under- and over-inclusive, arguably excluding established categories of actors who are subject to fiduciary duties, while perhaps including many relationships that normally do not result in the imposition of fiduciary duties.
The most basic duty of a fiduciary is the duty of loyalty, which obligates the fiduciary to put the interests of the beneficiary first, ahead of the fiduciary's self interest, and to refrain from exploiting the relationship for the fiduciary's personal benefit. This gives rise to more specific duties, such as the prohibition against self-dealing, conflicts of interest, and the duty to disclose material facts . . .
In addition to a duty of loyalty, a fiduciary also owes a duty of care to carry out its responsibilities in an informed and considered manner and to act as an ordinary prudent person would act in the management of his or her own affairs . . .
A fiduciary duty may arise either expressly or impliedly.
A fiduciary duty arises expressly by contract when the parties specifically agree to a relationship, such as the attorney/client or agent/principal relationship, that is considered to be a fiduciary relationship . . . Statutes also expressly impose a fiduciary duty in a variety of relationships, including broker/client, trustee/beneficiary, guardian/ward, partners to partners, corporate directors to shareholders, general partners to limited partners, and managing members of limited liability companies to members.
Fiduciary duties may also be implied in law, regardless of whether contractual relations or formal writings exist or a statute imposes such a duty, when one party relies on another to act on the party's behalf and to look out for its best interests. This requires proper factual allegation of dependency by the party and an undertaking by the other side to advise, counsel, protect, or benefit the dependent party . . . ” (Mariani, Kammerer, Guffey-Landers 20-21)

Understanding Fiduciary Law by Contrasting It to Status and Contract Relations

The legal concept of fiduciary duty and obligation that is being broadened within complex, modern society can best be understood when contrasted to other legal obligations. Legal scholars have depicted these contrasts and have shown how these legal obligations serve to impact the nature of relationships within a society.
“Societies may be distinguished by the predominant social and legal relations through which their members interact . . .
Fiduciary relations and the rules that govern them can be better understood when compared to two other important relations: status and contract relations and the laws that govern them . . .
The parties to a status relation must rely on each other to satisfy their needs and desires. In a status relation, such as that of parent and child, one party (the Power Bearer) usually has a partial or full monopoly over the means for satisfying the needs of the other party (the Dependent) . . .
As a result of the Power Bearer's monopoly, the Dependent generally defers to the will of the Power Bearer in order to ensure the means for his own survival . . .
Unlike the parties in status relations, contract parties have many options for satisfying their needs. They determine their own needs, they bargain to obtain them, and they can enforce their bargains . . . Contract frees each party from domination by the other, making them more independent than in a status relation; but its price is the absence of security. No party to a contract has a general obligation to take care of the other, and neither has the right to be taken care of.
The main role of the law in contract relations is to prohibit the use of force and monopoly, and to enforce the rules the parties freely set for themselves . . .
As in a status relation, one party to a fiduciary relation is dependent on the other (the fiduciary). This dependence, however, is seldom as broad and pervasive as that in status relations. By definition, the entrustor becomes dependent because he (or she) must rely on the fiduciary for a particular service. The fiduciary, however, does not provide every service that the entrustor may need or desire.
Furthermore, the fiduciary himself (or herself) is not independent, except perhaps in the area of his particular function. He must seek other fiduciaries for other services. For example, money managers generally rely on physicians for medical treatment, while physicians may look to managers for investment advice. Thus, in a society with many types of fiduciaries, each person may sometimes be a Power Bearer and at other times be a Dependent . . .

In contrast to contract and status relations, in which both parties seek to satisfy their own needs and desires through the relation, fiduciary relations are designed not to satisfy both parties' needs, but only those of the entrustor . . .
Accordingly, the law of fiduciary relations should, if possible, preserve the best aspects of status and contract relations . . .
A society's entire structure can be influenced by its predominant relation . . .
A contract society values freedom and independence highly, but it provides little security for its members . . .
I submit that we are witnessing the emergence of a society predominantly based on fiduciary relations. In our society, affluence is largely produced by interdependence, but personal freedom is cherished. Society's members turn to an arbitrator, the government, to obtain protection from personal coercion by those on whom they depend for specialized services. A fiduciary society attempts to maximize both the satisfaction of needs and the protection of freedom.
Unlike status and contract societies, a fiduciary society emphasizes not personal conflict and domination among individuals, but cooperation and identity of interest pursuant to acceptable but imposed standards. It permits the government to moderate between altruistic goals and individualistic, selfish desires, as well as between the social goal of increasing the common welfare and the individual desire to appropriate more than a “fair share.” (Frankel 797-802)

Difficulties in Establishing Parameters of Fiduciary Relationships

Often it is difficult to determine the limits of the fiduciary relationship and it becomes important to establish a means to set its parameters and determine when the relationship needs to be modified or terminated. An article by Frankel examines the status of fiduciary rules as default rules: whether, and how, entrustors can waive fiduciary duties owed to them.
“Contractarians argue that fiduciary rules constitute default rules around which the parties can bargain. Anti-contractarians argue that at least some rules are mandatory and cannot be waived. In my opinion, most fiduciary rules constitute default rules. However, entrustors may only waive fiduciary duties owed to them if they follow a two-step procedure.
First, entrustors must be put on clear notice that, with respect to the particular duties that they waive, the can no longer rely on their fiduciaries; instead, the entrustors must fend for themselves, the fiduciaries must provide entrustors with information acquired by virtue of their position as fiduciaries to enable entrustors to make an informed independent decision regarding the waiver. In addition, entrustors become dependent on their fiduciaries and may not be able to monitor the quality of their services because: (1) the skills involved are not easily acquired or understood; (2) the cost to entrustors of monitoring and evaluating such services would undermine the utility of the arrangement; and (3) there exists no other effective alternative monitoring mechanism. In sum, fiduciary rules reflect a consensual arrangement covering special situations in which fiduciaries promise to perform services for entrustors and receive substantial power to effectuate the performance of the services, while entrustors cannot efficiently monitor the fiduciaries' performance . . . (Frankel 1210-1215)

Discontinuing a Fiduciary Relationship

Often discontinuing a fiduciary relationship can be a complicated undertaking.
“Fiduciary law allows such termination of the relationship with respect to specified transactions only if the parties follow a specific procedure. This procedure is designed to ensure an effective transition from the fiduciary mode in which fiduciaries rely on their fiduciary, to a contract mode in which parties rely on themselves. That is why fiduciaries must put entrustors on notice that, in connection with the specified transaction, entrustors cannot rely on their fiduciaries. That is why entrustors must be capable of bargaining independently with their fiduciaries and have the capacity to enter into bargains. That is also why, to allow entrustors to make informed decisions, fiduciaries must provide them with information regarding the transaction, especially when the fiduciaries acquired this information in connection with the performance of their services to the entrustors. This procedure is, and should remain mandatory . . . (Frankel 1210-1215)

Legal Expert's Possible Solution to Problem of Entrustors' Protection

“I then examine three possible solutions to public entrustors' protection. One is the proposed contractarian view which would eliminate fiduciary law and lead to the creation of property rights for corporate management in its office. The second solution is to impose all or most fiduciary rules as mandatory rules and ignore so-called consents by public entrustors. The third is to establish a government office as surrogate for consent by public entrustors, along the scheme established in the Investment Company Act of 1940. There are, no doubt, other solutions as well. I conclude that private and public fiduciaries should be subject to a separate body of rules and reject the contractarian view. (Frankel 1210-1215)

Applicability of Invention to Clarifying Parameters of a Fiduciary Relationship

Use of my invention for clarifying the parameters of fiduciary and contractual obligations can serve a useful purpose in determining the initial and ongoing parameters of fiduciary and contractual relationships and can also serve the purpose of placing entrustors and/or fiduciaries on notice as to when that relationship is being modified or terminated.
“While the parameters of the fiduciary relationship may be undefinable, the relationship itself is fundamentally concerned with persons who assume trustee-like positions with discretionary power over the interests of others. The relationship may arise expressly, through contracts and statutes, or may be implied under the specific circumstances of the parties' relationship, which often requires a factually intensive inquiry. Although arm's length business transactions generally do not create fiduciary relationships (because the parties are expected to pursue their own interests and, therefore, have no duty to protect the other's interests) a court may impose a fiduciary duty when one party assumes responsibilities beyond those normally required by an arm's length business transaction. It is never sufficient simply to decide that a fiduciary relationship exists. As addressed by Justice Frankfurter, in S. E. C. v. Chenery Corp., 318 U.S. 80, 86 (1943), “to say a man is a fiduciary only begins the analysis; it gives direction to further inquiry. To whom is he a fiduciary? What obligations does he owe as a fiduciary? And what are the consequences of his deviation from duty?” (Mariani, Kammerer and Guffey-Landers 27)

### SUMMARY

In accordance with my invention as described in parent patent application Ser. No. 13/507,647, now U.S. Pat. No. 8,452,685, a psychometric test paired with an employee benefit or compensation program that determines understanding of various compensation or benefit plan options, serves to measure acceptable knowledge and competence to make plan selections and then as one possible intervention limits access to plan options based on the test outcome. Inability to demonstrate certain levels of mastery results in an individual having to re-test, engage in certain education or training before re-testing, obtaining proof of competent assistance in making plan choices, or being defaulted into an option with a lower level of overall risk. Demonstration of greater proficiency on the test permits a wider array of employee choice that presumably carries potential for greater rewards while at the same time possessing greater levels of risk. Access to a wider array of employee choice allows for greater individual customization to tailor the program to the individual's risk profile and desired investment or unique plan coverage requirements. As an alternative to actually limiting plan options, a plan sponsor may merely recommend that a plan participant restrict their choices to a universe of plan choices aligned with the participant's capability as demonstrated by test performance.

Accordingly several advantages of the invention accrue to both plan participants and plan sponsors. In a preferred embodiment of the invention, plan participants are denied access to plan features where they lack sufficient knowledge of the option or its related risks. In that way, the invention serves to limit unforeseen risk to plan participants. For the plan sponsor, the use of this invention provides an added safeguard for its employee that restricts plan participant access to features the employee fails to understand and which may be inappropriate plan choices for said individual. Use of the invention also serves to limit fiduciary liability for the plan sponsor potentially resulting in lowered legal costs and avoidance of fiduciary claims and direct legal fees associated with litigating such claims. Use of the invention also may reduce premium costs associated with fiduciary insurance provided by insurers. In addition to the advantages of the invention for the plan participants and plan sponsors, the invention provides a plan feature that holds value for insurance companies that provide insurance for fiduciary claims. Presumably this mechanism and screening method reduces the prevalence of fiduciary claims. Finally, the invention furthers the public policy objective of protecting the assets and avoiding undue risk for plan participants and beneficiaries covered by both ERISA and non-ERISA benefit plans.

Additionally, a comparable approach could be utilized to elucidate clarity regarding the terms of a fiduciary relationship between counter-parties or to elucidate a clear understanding of contractual terms when dealing with a contractual relationship. Specifically, this would entail using a psychometric instrument as a means of ascertaining agreement and common understanding of the parameters of a fiduciary relationship and/or the contractual terms agreed to by the parties to a contract. Failure to obtain an acceptable score on the psychometric instrument, or supplying a wrong answer on a question relating to a critical provision or issue, would result in the need for producing more detailed clarifying documentation between fiduciary and entrustor and/or contracting parties.

### BRIEF DESCRIPTION OF THE DRAWINGS

FIG. 1 is a macro-level diagram illustrating potential plan sponsor approaches to reduce or eliminate fiduciary liability exposure by using a psychometric testing instrument in accordance with my invention. FIG. 1 shows two broad approaches plan sponsors may use. Plan sponsors may either use the testing instrument to recommend a universe of investments a plan participant should select within, or the plan sponsor may take a more restrictive “gatekeeper approach” and actually restrict the universe of available investments based on an individual participant's performance on the psychometric testing instrument.

FIG. 2 is a flowchart showing how the business method for compensation or benefit plan selections and transactions occurs in accordance with my invention when the performance on a psychometric testing instrument is used to actually limit the array of acceptable plan choices and executable plan transactions made available to the individual participant.

Within the context of these drawings, a fiduciary is reducing or eliminating fiduciary liability by clarifying elements of financial literacy when permitting the entrustor (In this case, a plan participant) to select earmarked investments. As indicated above, said approach of using a psychometric instrument could be utilized in myriad alternate ways to reduce or eliminate fiduciary, product liability and/or contractual liability by making determinations of a common understanding on delegation of duties, expected performance and/or agreed upon approaches and/or outcomes, etc.

### DETAILED DESCRIPTION—PREFERRED EMBODIMENT

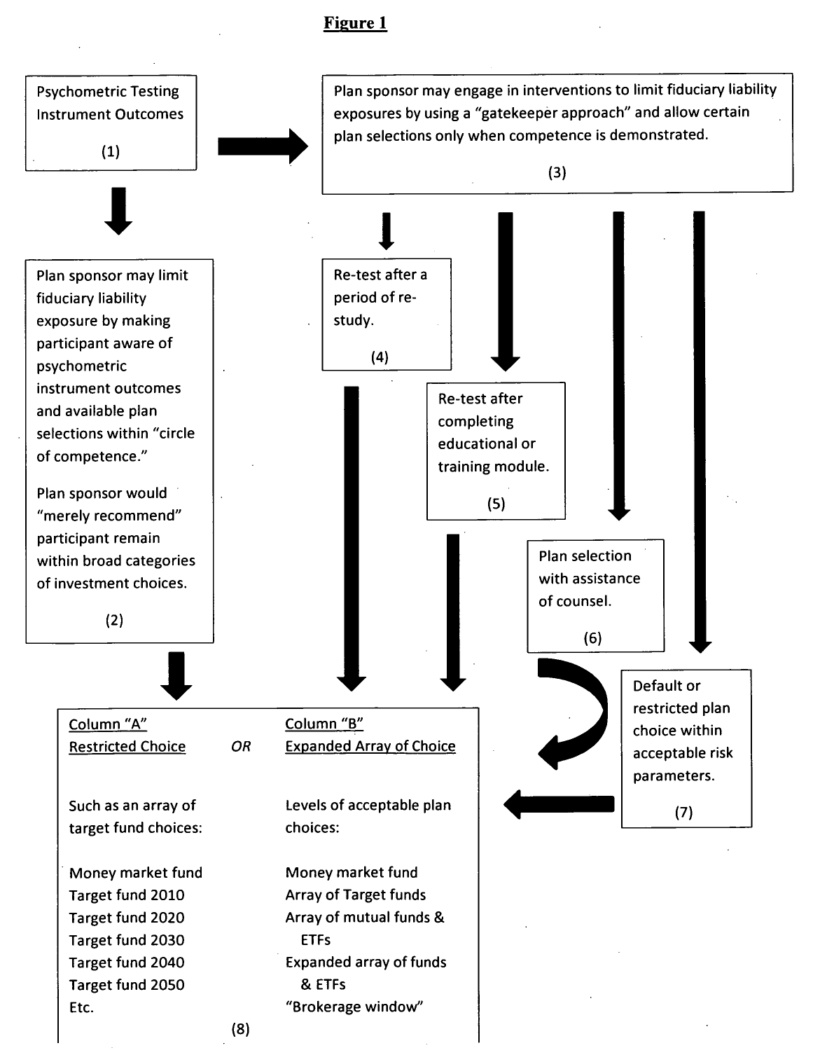

### FIG. 1: Use of Psychometric Testing Instrument to Limit Fiduciary Liability

FIG. 1 is a flowchart depicting alternative actions that a plan sponsor may take in an attempt to limit fiduciary liability. Following the reporting of participant performance on the psychometric testing instrument at position 1, the plan sponsor may either recommend a universe of acceptable investments moving to position 2 or use the more restrictive approach of actually limiting participant choices by moving to position 3. (Alternatively, a hybrid approach also may be used where an employer makes recommendations as noted at position 2, but uses a more restrictive policy as indicated at position 3 if scores on the psychometric test are below a certain level.)

### Position 2: “Merely Recommending” Broad Categories of Investment Choices:

In keeping with the path of position 2, a plan sponsor may recommend that a participant choose between a money market fund or a menu of target retirement funds (Column A at position 8). A plan sponsor may choose to offer the menu of default investments specifically identified as acceptable default investments in the guidance promulgated by the Department of Labor, Default Investment Alternatives under Participant Directed Individual Account Plans, 29 CFR Part 2550. Alternatively, a plan sponsor may indicate that the participant has demonstrated an understanding of a more expanded array of investment choices (Column B at position 8). It is important to realize that these are not investment recommendations or investment advice, but counsel on demonstrated knowledge of investments. The plan sponsor is merely suggesting that the individual not move beyond the boundaries of his or her “circle of competence” if the test is providing evidence that the participant does not understand benefit plan options or the risks that accompany these choices.

### Position 3: A “Gatekeeper Approach” Where Choices are Limited Unless Competence is Demonstrated:

Following the more restrictive path of position 3, a plan sponsor requires demonstrated competence in order to make certain plan selections. If a plan sponsor implements a policy whereby demonstrated competency is required to access various plan choices, other policy decisions are required to determine whether the individual participant may use alternate paths to demonstrate competency. For instance, if a plan participant does not achieve a score that would allow access to the expanded array of benefit choices (Column B at position 8), he or she may be permitted to re-test after a period of re-study as indicated at position 4. Another alternative is to allow for re-testing after completion of an educational or testing module (position 5). Another alternative is to require plan selection with the assistance of counsel (position 6). Another alternative shown at position 7 is to immediately default the plan participant after one testing attempt into a certain benefit choice or alternatively to allow choice within a limited array of plan options (Column A at position 8) whose risk level is commensurate with the knowledge or ability demonstrated via test performance.

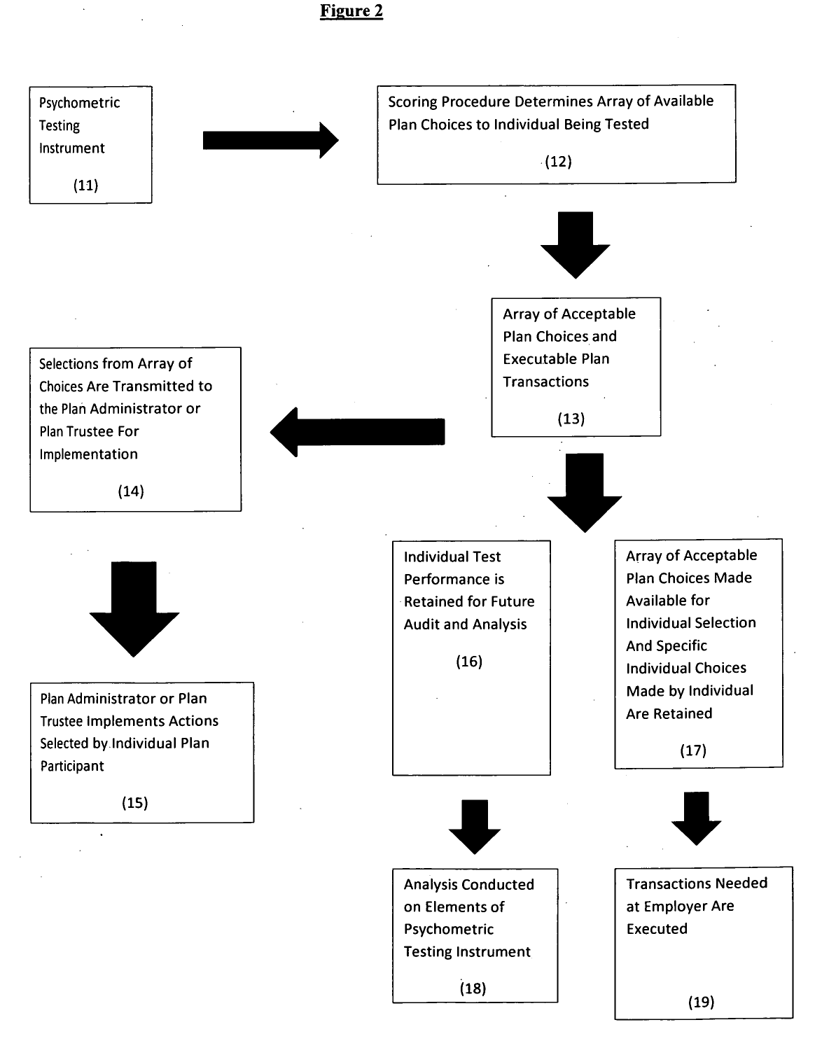

### FIG. 2: Method to Align Plan Selection Choices With Demonstrated Competency

FIG. 2 is a flowchart of a business method that occurs when the psychometric test either defaults participants into various plan choices or provides an array of limited plan choice. In FIG. 2 this business method begins with administration of the psychometric testing instrument to the plan participant occurring initially at position 11 before any compensation or benefit plan selections are chosen. Once the psychometric test is administered, the test undergoes a procedure where scoring occurs at position 12. Not only is a score computed for the psychometric test, but the level of the score then determines at position 13 the array of possible compensation and benefit plan choices for the individual participant to choose from. Lower scores on the psychometric test result in fewer and less risky plan choices. Higher scores allow for an expanded array of choices where plan participants may customize their program to a greater extent and assume greater risk while pursuing greater rewards. In a particular preferred embodiment of my invention the choice is either a full array allowing maximum choice or the defaulted choice depending upon whether or not the plan participant passes the psychometric test. In this particular embodiment of my invention, essentially with a “Pass-Fail” measure on the psychometric test, there is either “Choice or No Choice” in the selection of investments or benefit plan alternatives.

Once compensation and benefit plan selections are made, these choices are transmitted to the plan administrator or plan trustee at position 14 for implementation at position 15. Also, when the individual plan participant takes the test, his or her individual test performance is retained at position 16 for future audit and analysis at position 18. The employer also may retain the test-determined permissible plan choices for the individual participant and his or her specific selections at position 17 to process any business transactions internal to the employer at position 19. These internally processed business transactions at the employer may be such things as payroll deductions. If payroll processing is out-sourced to a third-party administrator, this information may be communicated to the third party.

### REFERENCE NUMERALS

### FIG. 1 Reference Numerals

01 psychometric testing instrument administered and outcomes received by plan administrator

02 plan sponsor uses test performance to recommend universe of investments

03 plan sponsor uses test performance to align plan choices with demonstrated competence

04 alternative of re-test after a period of re-study

05 alternative of re-test after completing educational or training module

06 alternative of plan selection with assistance of counsel

07 alternative of default or restricted plan choice within acceptable risk parameters

08 array of restricted choice and expanded choice plan alternatives

### FIG. 2 Reference Numerals

11 psychometric testing instrument administered to individual plan participant

12 scoring procedure which determines array of plan choices presented to individual participant

13 array of plan choices and executable plan transactions presented to individual plan participant

14 selections of plan choices and array of transactions sent to plan administrator or plan trustee post individual choice

15 executed transactions implemented by plan administrator or plan trustee

16 individual test results retained for future audit and analysis

17 array of acceptable plan choices presented to plan participant and individual selections made by plan participant

18 information (i.e., group statistics) is aggregated on psychometric testing instrument so analysis on instrument can be conducted

19 transactions needed at employer, such as withholdings from payroll, are executed by the employer

### Operation—Preferred Embodiment

In operation, a plan participant takes the psychometric test at hire or prior to entry into the plan, annually, or at predetermined regular time intervals to determine ongoing knowledge and competence, or when certain plan changes are initiated. Alternatively, the plan sponsor may run periodic reviews of plan choices and request demonstration of competency should individual plan choices indicate an undue risk profile or plan selections that are inconsistent. Upon completion of the test, knowledge and competencies are assessed and scored. At this juncture a plan sponsor may either recommend that an individual participant remain within a certain universe of choices, or use a gatekeeper approach where only certain choices are offered. Either an overall score or selected sub-scores in relevant competency or content areas may be used to identify the acceptable array of plan choices. Depending upon plan sponsor requirements and the advice of the plan sponsor's legal counsel, various alternative options may be presented to the plan participant. These possible options may include, but not necessarily be limited to, the following:
1. Re-test after a period of re-study.
2. Re-test after completing a specially designed educational or training module.
3. Provide a signed affidavit that outside counsel is being used to assist the plan participant in selection of an acceptable and appropriate plan option.
4. Default the plan participant into a plan option whose balanced characteristics mitigate risk or offer several risk-restricted choices.
   Besides the example given between a plan sponsor and a plan participant, any fiduciary or contractual relationship could use a psychometric testing instrument to reduce or eliminate potential fiduciary, product liability and/or contractual liabilities by verifying via testing such things as common assumptions and/or understanding concerning a product or fiduciary and/or contractual relationship.

An example of the operation of the psychometric test when paired with a profit sharing, 403(b) plan or 401(k) plan, may take the following form:

Psychometric test administered:
1.) At hire or
2.) Prior to the first date of initial eligibility to participate in the plan, and
3.) Subsequently annually one month prior to the start of the plan year.

Upon outcome of test, the test administrator forwards acceptable plan options to the plan participant who makes selections from available plan choices. These choices may include the following options:
1.) A money market account
2.) An array of age-related balanced lifestyle funds, and the option shown in 1.) above
3.) An expanded array of mutual funds and exchange traded funds meeting minimal 404(c) investment choice requirements, plus options shown in 1.) and 2.) above
4.) A more expanded array of mutual funds and exchange traded funds, inclusive of the options shown in 1.), 2.) and 3.) above, but adding even more options involving choices with greater historical risk and price volatility measures
5.) Option 4.) above, but with a brokerage window option offered where the plan participant may select individual stocks, bonds, commodities, options, etc.

As is evident from the previously described array of investment options, greater investment knowledge and sophistication is expected if the individual seeks to engage in investment strategies allowed in those options ascending to option 5.).

### Rules for Sample 401(k) Plan Choices:

Those who have failed to enroll in the plan by signing an application and who are subject to automatic enrollment in the plan may be defaulted into a selected option, such as Options 1, 2, or 3.
Those not achieving a minimal score for knowledge of investment options or portfolio construction may be restricted to either Options 1, 2, or 3.
Those achieving higher scores may choose the alternatives permitted in Options 1, 2, 3 and 4.
Those demonstrating achievement of the highest levels of knowledge and competency on the test may be permitted to select Options 1, 2, 3, 4, or 5.

Alternatively, plan rules may offer multiple plan options, but require certain threshold weightings within various asset classes. A variety of portfolio construction approaches may be possible. The key element in these various approaches is that the plan sponsor restricts the individual plan participant to investment choices that limit risk to an acceptable level determined by the plan sponsor. Greater risk and the potential for greater reward under a more customized program is only permitted when the plan participant provides evidence of knowledge and competency via improved performance on the testing instrument or seeks counsel from professional advisors.

### Description—Alternative Embodiment

Although the preferred embodiment of this invention describes a business method that may be implemented involving an employee benefit plan or an investment management scenario, a more universal approach is also possible. A psychometric test may be used for testing knowledge and aptitudes concerning a fiduciary relationship or contractual relationship. This more universal test or series of tests may be administered to anyone at any time. Test results from this more universal test may be used to reduce fiduciary, product liability and/or contractual liability as done in the preferred embodiment of the invention described above. Accordingly, those results may be utilized to make recommendations concerning a change to the fiduciary relationship and/or contractual relationship. This more general approach may become popular if the practice of administering a psychometric test becomes more widely used in practice for transacting business once introduced.

### Operation—Alternative Embodiment

Under the more universal embodiment described in the immediately preceding section, a party may rely on a designated third party to administer a more universal test to its many clients concerning product knowledge, fiduciary relationships and/or contractual terms. These scores may then be used to make recommendations or to offer options under the host party's business practices that are consistent with the test scores of the individual or group test takers. An advantage of this approach is that a much larger pool of more frequent test takers creates an ongoing business method where test questions may be tailored to recent environmental occurrences. A larger pool of test takers created by this embodiment also provides more statistical data on the specific test questions and the opportunity to develop and substitute more questions more frequently enhancing the overall relevancy and quality of the psychometric testing instrument. This more universal approach provides the advantages of added efficiencies and lowered costs in enhancing counter-party and/or contractual party knowledge and lowering host party fiduciary, product liability and/or contractual liability.

What is claimed:

1. A computer implemented method of limiting a fiduciary's and/or its counter-party's (‘entrustor's’), subcontractor's, regulator's or other individual's or entity's risks or benefits which could give rise to any adverse or beneficial consequence and/or reputational risk or benefit comprising:
administering a psychometric test to an individual or group of individuals via a display and input device to determine understanding of facts, concepts, learned items, knowledge, subject matter, competencies, abilities, standards, claimed understanding, agreements, representations, contractual terms, organizational policies, prescribed procedures, dangers, potential risks, assumption of risks, intended actions, likely or possible consequences or any other talent or type of dexterity or testable skill, knowledge or aptitude whose clarification and/or measurement could have relevance to either the intended actions or behaviors of a fiduciary or the entrustor's understanding of duties delegated, claimed expertise of the fiduciary, and/or representations of duties assumed and expected actions in pursuit of outcomes;
scoring the psychometric test to obtain a test score;
mapping the test score to various possible options based upon the individual's or group's level of measured knowledge and/or capabilities demonstrated by the test;
allowing intervention or action as a result of the psychometric test score;
limiting fiduciary liability and/or entrustment by
displaying and allowing either or both parties to the fiduciary relationship to better understand the knowledge, skill set, expectations and/or understanding of the fiduciary relationship so as to continue with, modify in relevant manner, or terminate the fiduciary and/or contractual relationship based upon results of the administered psychometric testing instrument and/or
defaulting the individual into a certain course of action or alternative; and/or
executing via the computer, business transactions to make selections of alternatives or courses of action, or following of advice consistent with those options permissible based upon said test score and said individual selection.

2. The computer implemented method of claim 1, wherein the psychometric test includes test questions, or items, containing objective content material or tasks able to demonstrate competencies that are relevant to a course of action involving continuation, modification, extension or cessation of the fiduciary and/or contractual relationship.

3. The computer implemented method of claim 1, further including creating an array of options or alternatives, wherein aggregation of options or alternatives is grouped in such a manner as to create greater illumination or clarification of relevant information regarding the fiduciary and/or contractual relationship.

4. The computer implemented method of claim 1, wherein performance on content areas in the psychometric test is used to provide relevant information and/or an array of recommended or allowable options or alternatives.

5. The computer implemented method of claim 1, the engaging step comprising recommending that the individual choose within a certain universe of computer-generated choices or seek additional information from the counter-party to the fiduciary and/or contractual relationship.

6. The computer implemented method of claim 1, the engaging step comprising limiting the array of choices to select from depending on the test score and/or pointing to areas of dissonance or differences in understanding which require resolution between the counterparties involved within the fiduciary and/or contractual relationship.

7. A computer implemented method of screening or assessing a fiduciary's and/or its counter-party's (entrustor's’), subcontractor's, regulator's or other individual's or entity's agreement to terms, assumptions, understanding and/or representations regarding a fiduciary and/or contractual relationship which could cause to arise any disagreement, misunderstanding or any adverse or beneficial consequence and/or reputational impact comprising:
administering a psychometric test to an individual or group via a display and input device to determine understanding of facts, concepts, learned items, knowledge, subject matter, competencies, abilities, standards, claimed understanding, agreements, representations, contractual terms, organizational policies, prescribed procedures, dangers, potential risks, assumption of risks, intended actions, likely or possible consequences or any other talent or type of dexterity or testable skill, knowledge or aptitude whose clarification and/or measurement could have relevance to either the intended actions or behaviors of a fiduciary or the entrustor's understanding of duties delegated, claimed expertise of the fiduciary, and/or representations of duties assumed and expected actions in pursuit of outcomes;
scoring the psychometric test to obtain a test score;
mapping the test score to various possible options and/or alternatives based upon the individual's or group's level of measured knowledge and/or capabilities demonstrated by the test;
screening or assessing a fiduciary's and/or its counter-party's (entrustor's), subcontractor's, regulator's or other individual's or group's agreement to terms, assumptions, understanding and/or representations regarding a fiduciary and/or contractual relationship which could give rise to any disagreement, misunderstanding or any adverse or beneficial consequence and/or reputational impact based upon the individual's and/or group's level of measured knowledge and/or capabilities demonstrated by the test;
allowing intervention or action as a result of the psychometric test score;
screening or assessing previously referenced characteristics by
displaying and allowing either or both parties to the fiduciary and/or contractual relationship to better understand the knowledge, skill set, expectations and/or understanding of the fiduciary and/or contractual relationship so as to continue with, modify in relevant manner, pr terminate the fiduciary and/or contractual relationship based upon the results of the administered psychometric testing instrument and/or
defaulting the individual and/or group into a certain course of action or alternative; and/or
executing via the computer, business transactions to make selections of alternatives or courses of action, or following advice consistent with those options or alternatives permissible based upon said test score and said individual or group selection,
whereby any party to the fiduciary and/or contractual relationship (i.e., fiduciary, entrustor, subcontractor, regulator or other individual or entity) can provide at least the test score as evidence of individual awareness regarding terms of agreement to the fiduciary and/or contractual relationship and prescribed expectations concerning pursuit of outcomes or furtherance of objectives due to a fiduciary and/or contractual relationship.

8. The computer implemented method of claim 7 wherein the psychometric test includes test questions, or items, containing objective content material or tasks able to demonstrate competencies that are relevant to a course of action involving continuation, modification, extension or cessation of the fiduciary and/or contractual relationship.

9. The computer implemented method of claim 7, further including creating an array of options or alternatives, wherein aggregation of these options or alternatives is grouped in such a manner as to create greater illumination and/or clarification of relevant information regarding the fiduciary and/or contractual relationship.

10. The computer implemented method of claim 7 wherein performance on content areas in the psychometric test is used to provide relevant information or an array of recommended or allowable options and alternatives.

11. The computer implemented method of claim 7, the engaging step comprising recommending that the individual or group choose within a certain universe of computer-generated choices or seek additional information from the counter-party to the fiduciary and/or contractual relationship.

12. The computer implemented method of claim 7, the engaging step comprising limiting the array of choices to select from depending on the test score or pointing to areas of dissonance or differences in understanding which require resolution between the counterparties involved within the fiduciary and/or contractual relationship.

13. A computer implemented method of limiting a fiduciary's and/or its counter-party's (‘entrustor's’), subcontractor's, regulator's or other individual's or entity's risks or liability which could give rise to any adverse or beneficial consequence and/or reputational risk comprising:
using an input and display device to administer a test and to obtain answers from an individual or group on understanding of facts, concepts, learned items, knowledge, subject matter, competencies, abilities, standards, claimed understanding, agreements, representations, contractual terms, organizational policies, prescribed procedures, dangers, potential risks, assumption of risks, intended actions, likely or possible consequences or any other talent or type of dexterity or testable skill, knowledge or aptitude whose clarification and/or measurement could have relevance to either the intended actions or behaviors of a fiduciary or the entrustor's understanding of duties delegated, claimed expertise of the fiduciary, and/or representations of duties assumed and expected actions in pursuit of outcomes arising from a fiduciary and/or contractual relationship; and/or
limiting fiduciary, product liability and/or contractual liability exposure or providing relevant information to amend the terms of the fiduciary and/or contractual relationship by displaying additional information and/or allowing selection of those options and alternatives determined to be understood by the individual based upon the answers to the test, or responsibly chosen with documentable advice provided by a competent advisor.

14. A computer implemented method of diagnosing understanding of facts, concepts, learned items, knowledge, subject matter, competencies, abilities, standards, claimed understanding, agreements, representations, contractual terms, organizational policies, prescribed procedures, dangers, potential risks, assumption of risks, intended actions, likely or possible consequences or any other talent or type of dexterity or testable skill, knowledge or aptitude whose clarification and/or measurement could have relevance to either the intended actions or behaviors of a fiduciary or the entrustor's understanding of duties delegated, claimed expertise of the fiduciary, and/or representations of duties assumed and expected actions in pursuit of outcomes arising from a fiduciary, business and/or contractual relationship and a means to design training and/or education on said subject matter, comprising:
using an input and display device to administer a test and to obtain answers from an individual or group on potential choices associated with a fiduciary, business and/or contractual relationship or following advice as given by an advisor or service provider; and/or
limiting fiduciary, product liability and/or contractual liability exposure and/or clarifying elements of the fiduciary, business and/or contractual relationship by displaying and allowing selection of those options and alternatives determined to be understood by the individual or group based upon the answers to the test, and/or responsibly chosen with documentable advice provided by a competent advisor, and/or yielding a checklist, questionnaire or other legal or clarifying document or repository of information whose completion will provide documentable evidence of shared understanding and agreement.

15. The interface and required steps within an automated business transaction in which completion and scoring of a computer implemented, valid psychometric instrument is inserted within the chain of required steps to effectuate the completed business transaction or limits or expands viable or permitted choices appropriately matched to outcomes or measures determined by the testing instrument. The psychometric instrument whose completion is necessary as a prerequisite to proceed with the selection of a product or service, or whose administration and scoring determines the items to be offered as various alternative products or services is coupled with some type of self-service selection, access or purchase either via the Internet or via a computer or display and input device; whereby the use of the valid psychometric instrument serves a “gatekeeper function” limiting the customer from selecting inappropriate, restricted, or potentially adverse choices and whose completion serves to provide evidence that the provider and/or distributor of the product or service has exercised a fiduciary and/or contractual duty to limit access or ability to procure the product or service when inappropriate, or has made an effort to appropriately customize or make available only products or services that are most appropriately matched to the individual's (or group's) valid requirements who is engaging in the self-selection process.
